(19) United States
(12) Patent Application Publication
(10) Pub. No.: US 2017/0001369 A1
(43) Pub. Date: Jan. 5, 2017

(54) Connecting System for Connecting a Semifinished Product to a Positioning Member, and Method for Preparing the Semifinished Product

(71) Applicant: Bayerische Motoren Werke Aktiengesellschaft, Muenchen (DE)

(72) Inventor: Jan HODDE, Muenchen (DE)

(21) Appl. No.: 15/262,152

(22) Filed: Sep. 12, 2016

Related U.S. Application Data
(63) Continuation of application No. PCT/EP2015/059762, filed on May 5, 2015.

(30) Foreign Application Priority Data
May 20, 2014 (DE) 10 2014 209 523.9

(51) Int. Cl. B29C 65/62

(52) U.S. Cl. CPC B29C 65/62

(57) ABSTRACT

A connection system for connecting a semifinished product to a positioning member for at least positioning the semifinished product on at least one positioning means of a processing system for processing the semifinished product. The connection system has at least one joining device for joining the semifinished product to the positioning member and at least one placing means placing the positioning member on the connection system.

### CROSS REFERENCE TO RELATED APPLICATIONS

This application is a continuation of PCT International Application No. PCT/EP2015/059762, filed May 5, 2015, which claims priority under 35 U.S.C. §119 from German Patent Application No. 10 2014 209 523.9, filed May 20, 2014, the entire disclosures of which are herein expressly incorporated by reference.

### BACKGROUND AND SUMMARY OF THE INVENTION

The embodiments of the present invention relate to a connection system for connecting a semifinished product to a positioning member in order to at least position the semifinished product on at least one positioning means of a processing system for processing the semifinished product. The embodiments of the present invention also relate to a method for preparing a semifinished product which by means of a connection system for connecting the semifinished product to a positioning member is disposable in at least a processing system for processing a semifinished product.

In order for semifinished products such as, in particular, impregnated semifinished products and, in particular, impregnated semifinished fibrous products to be handled, grippers which clamp the semifinished product at the peripheries thereof and consequently may also be referred to as clamping grippers are employed. However, it is disadvantageous that the position of the semifinished product by means of these grippers cannot be maintained in a precise and stable manner at least during transportation of the semifinished product from a first processing system to a second processing system. Consequently, in order for these semifinished products to be transported and/or for the semifinished products to be disposed in the region of a processing system such as, for example, an injection system or an impregnation system, respectively, or else a consolidation system, so-called positioning means or receptacle means, respectively, are used which are advantageously configured in the form of a pin or a plug, respectively, or else of a bar. These positioning means may extend at least in portions through respective recesses such as, for example, bores or through bores, respectively, and consequently through the material thickness of the semifinished product. By means of positioning means or receptacle means, respectively, of this type it is possible for the semifinished product by means of the transportation system during transportation and also by means of the processing system during processing to be retained in a predefined position. To this end it is necessary for the semifinished products to have respective recesses or bores, respectively, which consequently have to be incorporated in respective regions of the semifinished product prior to the latter being processed in the individual processing systems, for example. In order to save costs during manufacturing of the semifinished product it is advantageous for the respective recesses not to be incorporated within the semifinished product per se, in particular because peripheral regions of this type which are provided with the respective recesses have to be removed again once the semifinished product has been processed, so as to make available a completed final component. On account thereof, an excessive amount of waste would be generated, on account of which the manufacturing costs of the semifinished product would consequently be increased.

In this way it is conceivable for positioning members which as additional elements are disposed in particular in the peripheral regions and advantageously in overlap regions of the semifinished product and are fixed to the semifinished product to be used. Fixing the positioning members to the semifinished product and in particular to the overlap regions of the semifinished product is possible by means of a sewing system and advantageously a 2D portal sewing system, for example. However, it is also conceivable for the positioning members to be connected to the overlap regions of the semifinished product by using other releasable or else non-releasable connection means such as, for example, screws, rivets, adhesive means, etc. The use of the connection methods of welding, folding, or clinching, or of equivalent methods, is also conceivable here. The blank of the semifinished product is advantageously minimized and semifinished material is saved by advantageously attaching positioning members or at least one positioning member to the semifinished product, and in particular at least to an overlap region of the semifinished product. In particular, the positioning members are advantageously made from a material which deviates from that of the semifinished product and in particular is more cost-effective than the latter, said positioning members consequently having a material of lesser quality.

Impregnated semifinished fibrous products are used in the aircraft and aerospace industries as well as in the vehicle industry, and are known to be referred to as prepregs. Prepregs are mainly flat planar fibrous structures which in a continuous process are impregnated with a matrix system to the desired resin-to-fiber ratio. In essence, there are two known textile structures, for example the unidirectional prepreg in which all fibers in the layer are aligned in parallel, and on the other hand woven prepregs having a series of dissimilar types of woven fabrics. As is known, industrial manufacturing of impregnated fiber-composite semifinished products is performed by manual lamination in the wet-pressing method, in the prepreg-pressing method, or in the resin-infusion method such as, for example, the resin transfer molding (RTM) method. In the case of all abovementioned methods, a semifinished product made from man-made fibers, for example, is laid up in an impregnation tool, in particular in an impregnation device or an injection system, respectively, and soaked or sprayed using an impregnation means such as, for example, an impregnation resin, the impregnation means penetrating through the cavities between the fibers and encasing the latter. After the impregnation process the semifinished product which is soaked with the impregnation means is laid up in a respective forming tool, in order for the semifinished product to be pressed; said forming tool may also be referred to as a consolidation system. During this pressing procedure the structure of the impregnated semifinished fibrous product in particular is cross-linked, and the semifinished product is shaped. In order for transportation of the semifinished product intended for processing and in particular of the semifinished product soaked with impregnation resin to the consolidation device to be enabled it is necessary for the semifinished product to be received by means of a transportation system and to be transported out of the impregnation tool to the consolidation tool, and to be transferred to the latter. To this end, precise receiving and depositing is required.

In order for semifinished products intended for processing, which have respective positioning members, to be used it is necessary for these positioning members to be disposed at a defined position on the semifinished product, such that the semifinished product by means of the respective transportation system may be transported and by means of the respective processing system may be processed.

It is therefore an object of the embodiments of the present invention to provide a connection system for connecting a semifinished product to a positioning member, and a method for preparing a semifinished product which by means of a connection system is disposable at least in a processing system for processing a semifinished product, by means of which a predefined and precise disposal of the positioning member on the semifinished product, and in particular on overlap regions of the semifinished product, may be enabled in a simple and cost-effective manner.

This and other objects are achieved by a connection system for connecting a semifinished product to a positioning member for at least positioning the semifinished product on at least one positioning means of a processing system for processing the semifinished product. The abovementioned object is furthermore achieved by means of a method for preparing a semifinished product which by means of a connection system for connecting the semifinished product to a positioning member is disposable in at least a processing system for processing a semifinished product. Further features and details of the invention are derived from the dependent claims, from the description, and from the drawings. Herein, features and details which are described in the context of the connection system of course also apply in the context of the method according to the embodiments of the invention, and vice-versa, such that reference relating to the disclosure of the individual aspects of the embodiments of the invention is at all times made or may be made, respectively, in a reciprocating manner. Moreover, the method according to the embodiments of the invention may be carried out by using the connection system according to the embodiments of the invention.

The connection system according to the embodiments of the invention for connecting a semifinished product to a positioning member for at least positioning the semifinished product on at least one positioning means of a processing system for processing the semifinished product has at least one joining device for joining the semifinished product to the positioning member and at least one placing means for placing the positioning member on the connection system. The connection system is advantageously a joining system which serves for connecting at least one positioning member to the semifinished product, in particular to at least one overlap region of the semifinished product. Depending on the configuration of the connection system, the joining device of the connection system is a sewing head, for example, or else a welding head, a riveting head, a clinching head, etc., so as to produce a releasable or non-releasable connection between the positioning member and the semifinished product, with or without a respective releasable or non-releasable connection means, respectively.

The placing means of the semifinished product advantageously serves for disposing the at least one positioning member, and advantageously a plurality of positioning members, at a predefined position within or on the connection system respectively, this positioning of the placing member in the connection system corresponding to the later positioning of the positioning member in terms of the positioning means or of the receptacle means, respectively, of the processing system or of the transportation system, respectively. It is thus conceivable that, by using the placing means, placing of the positioning member in relation to the joining device of the connection system is to be guaranteed per se, on the one hand, and/or also in relation to the semifinished product to which the positioning member is to be connected, on the other hand, such that predefined and consequently exact positioning of the positioning member on the semifinished product may be guaranteed. Exact positioning of the positioning member on the semifinished product, in particular on the overlap region of the semifinished product, advantageously serves for the semifinished product, in particular the positioning member which is connected to the semifinished product, being able to be received or gripped, respectively, by the positioning means or the receptacle means, respectively, of the processing system or of the transportation system, respectively.

The transportation system, or the transportation system per se, respectively, advantageously serves for transporting the semifinished product from a processing system or a processing device, respectively, to another processing system, wherein a processing system may be, for example, an injection system or an impregnation system, respectively, or else a consolidation system such as, for example, a pressing system. It is furthermore conceivable that the placing means may be, for example, a gripping element, a clamping element, a pin or a plug, respectively, or a bar-shaped element which serves for gripping or penetrating, respectively, a disposing element of the positioning member. The disposing element of the positioning member is advantageously a bore, in particular a through bore, or else a protrusion such as, for example, a lug or a hook, in which it is also conceivable for the disposing element per se to potentially be a recess or a clearance with or without an undercut, respectively.

Advantageously, the disposing element of the positioning member is also configured depending on the configuration of the placing means of the connection system. This means that in the case of a gripping element or of a clamping element, respectively, being present as the placing means, the positioning member advantageously has a protrusion or a hook element, respectively, and similar as a disposing element, which may engage with the gripping element or with the clamping element, respectively. In this way it is consequently conceivable that in the case of the placing means being configured in the form of a pin or of a plug, respectively, the positioning member per se as the disposing element has a bore, in particular a through bore, through which the placing means, in particular the placing pin or plug, respectively, at least in regions may engage.

Consequently, it is conceivable in the context of the invention that the placing means has a geometrical shape which at least in portions interacts with a geometrical shape of a disposing element of the positioning member. If and when the placing means of the connection system consequently has a circular, in particular a circular-cylindrical design it is advantageously possible for the disposing element of the positioning member to be configured in the form of a bore, in particular of a through bore, and consequently of a circular through bore. To the extent that the placing means has a circumferential shape which is angular, for example triangular or rectangular, it is consequently also possible that, as a result thereof, the disposing element is configured as an angular clearance. On account thereof, disposing the positioning member on or on top of the placing means, respectively, is advantageously enabled to an exact fit.

It is furthermore conceivable that the placing means is a placing pin or a placing plug which, in order to at least retain the semifinished product, extends from a retaining means of the connection system. The retaining means of the connection system for retaining the semifinished product advantageously is a carrier element in the form of a carrier table on which the semifinished product is disposed at least while the semifinished product is connected to the positioning member. Proceeding from this retaining means it is also conceivable that the placing means advantageously extends in the vertical direction and, accordingly, in a perpendicular manner at an angle of preferably approx. 90° in relation to the bearing surface of the retaining means on which the semifinished product is disposed. In the case of a corresponding configuration of the placing means in the form of a placing pin or of a placing plug, respectively, the positioning member advantageously has clearances in the form of bores, in particular of through bores, by means of which the positioning member may be plug-fitted onto the placing pin or the placing plug, respectively, such that the placing pin or the placing plug, respectively at least in portions advantageously extends through these bores or clearances, respectively. As has been mentioned before, it is furthermore conceivable that the placing means is also a gripping element or also a clamping element which consequently grips or fixedly clamps a protrusion or a hook element, respectively, or else a lug element of the positioning member.

In the context of the invention it is furthermore conceivable for the connection system to have an alignment means for aligning the semifinished product in a manner relative to the placing means. The alignment means for aligning the semifinished product advantageously serves for disposing the semifinished product and for aligning the latter in a manner relative to the at least one placing means and, accordingly, to the positioning member which is disposed on the placing means. It is furthermore also conceivable for the connection system to have not only one positioning means but a plurality of positioning means, in particular two or more thereof, which are disposed so as to be mutually spaced apart by a defined and predefined positioning. Accordingly, it is possible for a plurality of positioning members to also be disposed on the semifinished product. In the case of a plurality of placing means being present, the alignment means at least in portions is advantageously disposed in a region between the placing means, since the semifinished product may have more than one positioning member, wherein the at least two positioning members when viewed in the circumferential direction of the semifinished product are disposed on mutually opposite sides so as to extend in substantially one plane. The alignment means of the connection system may be a groove, a depression, or a recess, for example, in a region of the retaining means on which the semifinished product will be disposed, and which alignment means consequently prevents slippage of the semifinished product. Consequently, it is conceivable for at least one portion of the semifinished product to be able to be disposed in this depression or recess, respectively, wherein this depression or recess, respectively, and consequently the alignment means may advantageously have a geometrical shape which is comparable to that of the semifinished product or of a portion of the semifinished product, respectively. It is furthermore conceivable that the alignment means also is configured in the form of a pin, of a plug, of a guide wall, of a gripper, of a clamping element, or similar. An alignment means which is configured in such a geometrical manner at least in portions advantageously extends from the retaining means for example in the direction of a disposed joining device, advantageously serving for positioning the semifinished product and optionally for locking the latter during the joining method or the connection method, respectively.

It is furthermore conceivable for the connection system to be a sewing system, in particular a two-dimensional portal sewing system. A portal sewing system of this type operates having at least one sewing head, and advantageously having a plurality of sewing heads, wherein in particular a connection thread such as, for example, a yarn, a glass-fiber thread, a polyester thread, or an aramid thread is used as a connection means.

Consequently, it is conceivable in the context of the invention for the joining device to have a joining element, wherein the joining device is in particular a sewing head, and the joining element is in particular a needle element. The positioning member is advantageously sewn to the semifinished product, in particular to an overlap region of the semifinished product, by means of the sewing head, wherein a backstitch, a blind stitch, a (single thread) chain stitch, or a double stitch, or the equivalent, may be used in the seam for example. It is furthermore conceivable for the semifinished product, in particular an overlap region of the semifinished product on which the positioning member will be disposed, and/or for the positioning member per se to already have bores, in particular, and advantageously holes, through which a thread element may be pulled through. In the case of a presence of correspondingly prefabricated regions of the semifinished product and of prefabricated regions of the at least one positioning member, threading of the thread element through the respective holes of the positioning member and/or of the semifinished product consequently takes place, using the connection system and the sewing head or the joining device, respectively. Simple connecting as well as releasing of the positioning member to or from the semifinished product, respectively, is advantageously achieved by using a sewing system and in particular a thread element.

Furthermore claimed is a method for preparing a semifinished product which by means of a connection system for connecting the semifinished product to a positioning member is disposable in at least a processing system for processing a semifinished product, the method having at least the following steps:

disposing the positioning member on a placing means of the connection system, in order to position the positioning member on the connection system; disposing the semifinished product on a retaining means of the connection system, wherein an overlap region of the semifinished product at least in portions is overlapped by the positioning member; and connecting the semifinished product to the positioning member by means of a joining device of the connection system.

It is consequently conceivable for the at least one positioning member, prior to the semifinished product being disposed on the retaining means of the connection system, to be disposed on the at least one placing means of the connection system, wherein it is also possible for the semifinished product to be positioned on the retaining means of the connection system prior to the positioning member being disposed on the placing means. The retaining means per se is advantageously a carrier element in the form of a table element on which the semifinished product is disposed, wherein it is conceivable for the at least one placing means to extend from the retaining means advantageously in the perpendicular direction, so as to receive the positioning member which advantageously has a clearance in the form of a bore, in particular of a through bore. However, it is also conceivable for the placing means per se to be configured in the form of a placing pin or of a placing plug, respectively, or of a placing bar, or else in the form of a gripping element or a clamping element, so as to grip or retain, respectively, the positioning member, in particular on respective disposing elements. By disposing the positioning member on the placing means, an erroneous disposal of the positioning member within the connection system is advantageously avoided. Connecting the semifinished product to the positioning member may be performed in a releasable or non-releasable manner by means of the use of a releasable or non-releasable connection means, or by not using any connection means. In this way, it is conceivable that a screw connection, or else a rivet connection, or else a sewn connection using a thread element, may be understood to be a releasable connection using a connection means. A non-releasable connection means advantageously is an adhesive means or else a welding means. However, it is also conceivable that a connection between the positioning member and the semifinished product may be produced without the use of an additional connection means, wherein consequently a clinching method, a folding method, or else a welding method may be employed as a connection method. By disposing the positioning member on a placing means of the connection system, the positioning member is intended to be advantageously disposed in a manner relative to the semifinished product, or in the case of at least two positioning members being present, in relation to the other positioning members on the semifinished product, for example, so as to consequently guarantee a defined disposal of the semifinished product prepared with the positioning member in a processing system and/or in a transportation system, wherein, on account thereof, slippage of the prepared semifinished product in the processing system is advantageously avoided at least during the processing procedure, and also in the transportation system at least during transportation of the semifinished product, for example, from a processing system to a further processing system.

It is consequently advantageously conceivable for a disposing element of the positioning member to be made to interact with the placing means. This means that the disposing means of the positioning member, which may represent a bore, for example, in particular a through bore, or else a protrusion or similar, is penetrated or retained or gripped, respectively at least in portions by the placing means. Slippage of the positioning member within the connection system for connecting the positioning member to the semifinished product is advantageously prevented on account thereof.

It is furthermore conceivable that the semifinished product by means of an alignment means of the connection system is positioned on the retaining means in a manner relative to the placing means. Positioning of the semifinished product in relation to the placing means may be performed either prior to the positioning member being disposed on top of or on the placing means, respectively, or after positioning the positioning member on top of or on the placing means, respectively. Exact positioning of the semifinished product on top of or on the retaining means in the connection system is advantageously enabled by using the alignment means, such that erroneous disposal of the semifinished product, for example in a laterally reversed manner, in the connection system is avoided.

It is furthermore conceivable for at least one connection system, and consequently a connection system of the aforementioned type, is used for carrying out the method.

All advantages which have already been described in the context of a connection system are also derived in the method described.

One embodiment of a transportation system and of a processing system, and embodiments of a semifinished product prepared with at least one positioning member, and one embodiment of a connection system will be explained in more detail hereunder by means of drawings in which, in each case in a schematical manner:

Other objects, advantages and novel features of the embodiments of the present invention will become apparent from the following detailed description of one or more preferred embodiments when considered in conjunction with the accompanying drawings.

### BRIEF DESCRIPTION OF THE DRAWINGS

FIG. 1 is a side view of a sectional illustration of a semifinished product retained by means of a transportation system;

FIG. 2 is a side view of a sectional illustration of a semifinished product which is disposed in a processing system;

FIG. 3a is a plan view of a semifinished product prepared with positioning members;

FIG. 3b is a plan view of another semifinished product prepared with positioning members;

FIG. 3c is a plan view of another semifinished product prepared with positioning members;

FIG. 3d is a plan view of another semifinished product prepared with positioning members; and

FIG. 4 is a side view of a sectional illustration of a connection system.

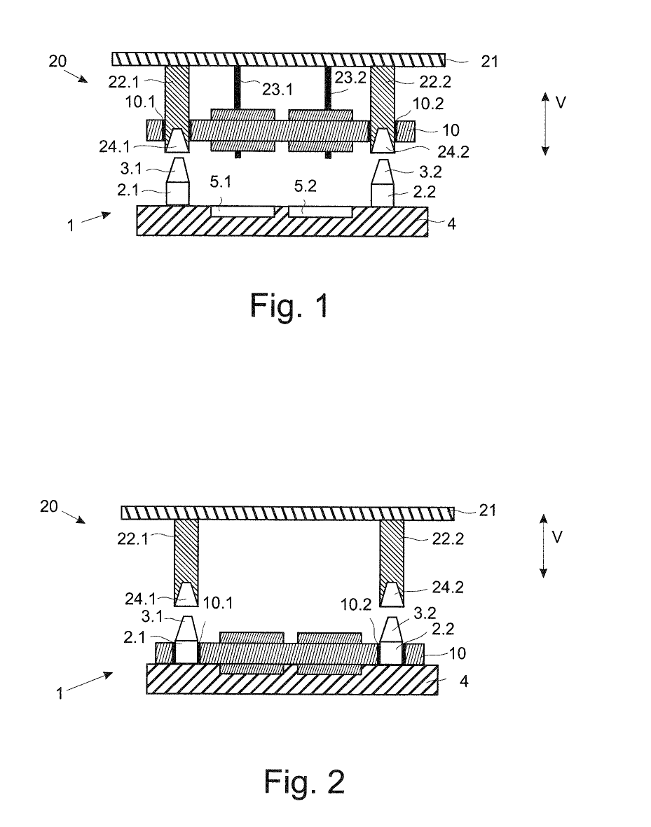

Elements having identical functions and operation modes are in each case provided with identical reference signs in FIGS. 1 to 4.

### DETAILED DESCRIPTION OF THE DRAWINGS

A side view of a sectional illustration of a processing system 1 and of a transportation system 20 is illustrated in FIG. 1. The processing system 1 may be an impregnation system or an injection system, respectively, or else a consolidation system, for example. The processing system 1 has a bearing element 4 from which positioning means 2.1 and 2.2, respectively, extend in the vertical direction V toward the transportation system 20. It is conceivable for the positioning means 2.1 and 2.2 to have engagement regions 3.1 and 3.2, respectively, so as to facilitate disposal of the receptacle means 22.1 and 22.2 of the transportation system 20. It is furthermore conceivable for the processing system 1 to have depressions 5.1 and 5.2, respectively, which are incorporated in the bearing element 4, so as to receive portions or regions of the semifinished product 10, respectively. The semifinished product 10 is disposed on the transportation system 20, and has bores 10.1 and 10.2, respectively, through which at least portions of the receptacle means 22.1 and 22.2, respectively, of the transportation system 20 extend. The transportation system 20 moreover has a carrier element 21 which locks the receptacle means 22.1 and 22.2, respectively, which extend from the carrier element 21 perpendicularly in the vertical direction V in the direction of the processing system 1. It is furthermore possible for the transportation system 20 to have locking means 23.1 and 23.2 which at least in portions engage below the semifinished product, serving for retaining or locking, respectively, the semifinished product 10 at least during transportation of the semifinished product 10 from a first processing system to a further processing system, for example. The receptacle means 22.1 and 22.2 moreover may have clearances 24.1 and 24.2 which are geometrically configured in such a manner that the engagement regions 3.1 and 3.2, respectively, of the positioning means 2.1 and 2.2, respectively, may at least in portions be engaged in said clearances 24.1 and 24.2. This is advantageous in particular when transferring of the semifinished product 10 from the transportation system 20 to the processing system 1 is to be enabled. A respective transfer of the semifinished product 10 is illustrated in particular in FIG. 2.

As is shown in FIG. 2, the semifinished product 10 is already disposed in the processing system 1 such that the positioning means 2.1 and 2.2, at least in portions extend through those bores 10.1 and 10.2, respectively, of the semifinished product 10 through which the receptacle means 22.1 and 22.2, respectively, of the transportation system 20 have previously extended. In order to consequently enable advantageous transportation of the semifinished product 10 by means of the transportation system 20 which is illustrated in FIGS. 1 and 2, and advantageous disposing of the semifinished product 10 in a correspondingly configured processing system 1 as is configured in FIGS. 1 and 2, it is necessary for the semifinished product 10 to have respective disposing elements such as, for example, bores 10.1 and 10.2 which may interact with the positioning means 2.1 and 2.2, respectively, and/or with receptacle means 22.1 and 22.2.

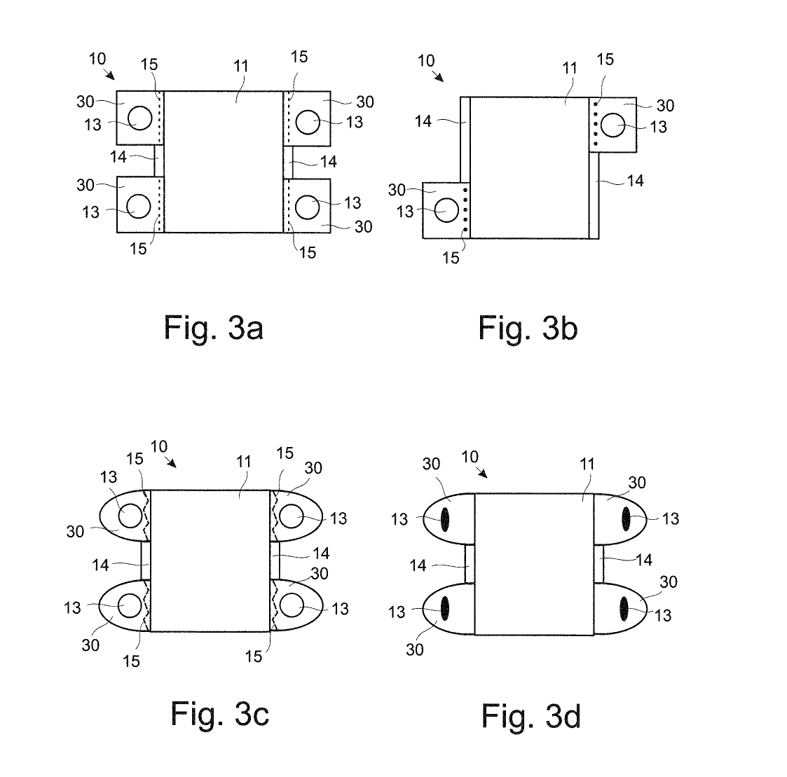

Semifinished products 10 prepared with positioning members are shown in FIGS. 3a to 3d. A semifinished product 10 which is prepared with positioning members 30 is shown inter alia in FIG. 3a in a plan view, which has a component region 11 and an overlap region 14, wherein the overlap region 14 advantageously extends outwardly from the component region 11, away from the component region 11. The overlap region 14 advantageously serves for connecting the at least one positioning member 30, and, as is shown in FIG. 3a, for advantageously connecting four positioning members 30 to the semifinished product 10. The positioning members 30 advantageously have disposing elements 13 which, as is shown in FIG. 3a, may be configured in the form of a bore. The positioning members 30 are disposed on the overlap region 14 of the semifinished product 10, or connected to the semifinished product 10, respectively, by means of a respective connection means 15 such as, for example, a thread element.

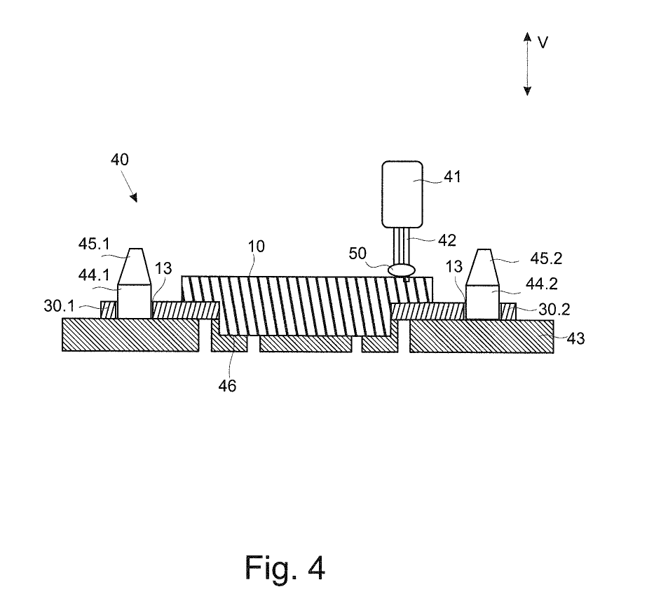

As is shown in FIGS. 3b to 3d, it is also conceivable for fewer than four positioning members 30, rather in particular only one or else two positioning members 30, such as shown in FIG. 3b, to be able to be disposed on the semifinished product 10 and to be releasably or non-releasably connected thereto. Moreover, it is also conceivable for the geometrical shape of the positioning members to be dissimilar. In this way, the positioning members 30, such as shown in the embodiments of FIGS. 3c and 3d, for example, have an oval or round shape, respectively, while the positioning members of the embodiments shown in FIGS. 3a and 3b, respectively, have an angular shape. It is furthermore conceivable for the positioning members 30, apart from the disposing elements 13 which are configured as bores or through bores, respectively, to have disposing elements 13 which are also configured in the form of protrusions such as those illustrated in FIG. 3d, so that respective gripping elements or clamping elements, respectively, of the connection system 40 (cf. FIG. 4) and/or of the processing system 1 (cf. FIG. 1 or 2) and/or of the transportation system 20 (cf. FIG. 1 or 2) may engage on these disposing elements 13. It is furthermore conceivable for rivet elements or screw elements, respectively, to be able to be used as connection means, as is shown in FIG. 3b, instead of a thread element as a connection means 15 as shown in FIG. 3a. As is elucidated in FIG. 3d, it is also conceivable for the positioning members 30 to be connected to the semifinished product 10, in particular to the overlap regions 14 of the semifinished product 10, by employing an adhesive means (not visible here).

A side view of a sectional illustration of an embodiment of a connection system 40 is shown in FIG. 4. The connection system 40 has a joining device 41 having a joining element 42 disposed thereon, wherein the joining device 41 per se may be a sewing head, and the joining element 42 may be a needle element, for example. It is consequently conceivable for the connection system 40 to be a sewing system, in particular a two-dimensional portal sewing system. Furthermore, the connection system 40 has a retaining means 43 from which placing means 44.1 and 44.2 advantageously extend perpendicularly upward in the vertical direction V and consequently in the direction of the joining device. The placing means 44.1 and 44.2 advantageously have introduction regions 45.1 and 45.2, respectively, so as to facilitate the disposal of receptacle means 22.1 and 22.2, respectively, of a transportation system 20, for example, as is shown for example in FIGS. 1 and 2. Furthermore, in FIG. 4 a connection means 50 is shown which in the case of a sewing system being present as the connection system 40 may be a thread element, so as to connect a semifinished product 10 to at least one positioning member 30, and as is shown in FIG. 4, to connect at least two positioning members 30.1 and 30.2. The retaining means 43 moreover has an alignment means 46 which, as is shown in FIG. 4, may be configured in the form of a recess or a clearance, respectively. Part of the semifinished product 10, or a portion thereof, respectively, is introducible in particular into this alignment means 46 so as to align or dispose, respectively, the semifinished product 10 in relation in particular to the placing means 44.1 and 44.2, such that the semifinished product 10 is consequently also aligned in relation to positioning members 30 which are disposed by way of the placing means 44.1 and 44.2.

List of reference signs

| | |
|---|---|
| 1 | Processing system |
| 2.1, 2.2 | Positioning means |
| 3.1, 3.2 | Engagement region of the positioning means |
| 4 | Bearing element |
| 5.1, 5.2 | Depression of the bearing element |
| 10 | Semifinished product |
| 10.1, 10.2 | Bore of the semifinished product |
| 11 | Component region |
| 13 | Disposing element |
| 14 | Overlap region |
| 15 | Connection means |
| 20 | Transportation system |
| 21 | Carrier element |
| 22.1, 22.2 | Receptacle means |
| 23.1, 23.2 | Locking means |
| 24.1, 24.2 | Clearance of the receptacle means |
| 30 | |
| 30.1, 30.2 | Positioning member |
| 40 | Connection system |
| 41 | Joining device |
| 42 | Joining element |
| 43 | Retaining means |
| 44.1, 44.2 | Placing means |
| 45.1, 45.2 | Introduction region of the placing means |
| 46 | Alignment means |
| 50 | Connection means |
| V | Vertical direction |

The foregoing disclosure has been set forth merely to illustrate the embodiments of the invention and is not intended to be limiting. Since modifications of the disclosed embodiments incorporating the spirit and substance of the embodiments of the invention may occur to persons skilled in the art, the embodiments of the invention should be construed to include everything within the scope of the appended claims and equivalents thereof.

What is claimed is:

1. A connection system for connecting a semifinished product to a positioning member for at least positioning the semifinished product on at least one positioning means of a processing system for processing the semifinished product, wherein the connection system has at least one joining device for joining the semifinished product to the positioning member and at least one placing means placing the positioning member on the connection system.

2. The connection system as claimed in claim 1, wherein
the placing means has a geometrical shape which at least in portions interacts with a geometrical shape of a disposing element of the positioning member.

3. The connection system as claimed in claim 2,
wherein
the placing means is a placing pin or a placing plug which, in order to at least retain the semifinished product, extends from a retaining means of the connection system.

4. The connection system as claimed in claim 3,
wherein
the connection system has an alignment means for aligning the semifinished product in a manner relative to the placing means.

5. The connection system as claimed in claim 4,
wherein
the connection system is a sewing system, in particular a two-dimensional portal sewing system.

6. The connection system as claimed in claim 5,
wherein
the joining device has a joining element, wherein the joining device is in particular a sewing head, and the joining element is a needle element.

7. A method for preparing a semifinished product which by means of a connection system for connecting the semifinished product to a positioning member is disposable in at least a processing system for processing a semifinished product, the method comprising the acts of:
disposing the positioning member on a placing means of the connection system, in order to position the positioning on the connection system;
disposing the semifinished product on a retaining means of the connection system, wherein an overlap region of the semifinished product at least in portions is overlapped by the positioning member; and
connecting the semifinished product to the positioning member by means of a joining device of the connection system.

8. The method as claimed in claim 7,
wherein
a disposing element of the positioning member is made to interact with the placing means.

9. The method as claimed in claim 8,
wherein
the semifinished product by means of an alignment means of the connection system is positioned on the retaining means in a manner relative to the placing means.

10. The method as claimed in claim 9,
wherein
in order for the method to be carried out a given connection system is used, the given connection system connecting a semifinished product to a positioning member for at least positioning the semifinished product on at least one positioning means of a processing system for processing the semifinished product, wherein the connection system has at least one joining device for joining the semifinished product to the positioning member and at least one placing means placing the positioning member on the connection system.
